(19) United States
(12) Patent Application Publication
(10) Pub. No.: US 2004/0204806 A1
(43) Pub. Date: Oct. 14, 2004

(54) Active rescue-asking burglar alarm system and its method

(75) Inventors: Kuo-Rong Chen, Panchiao City (TW); Chun-Chung Lee, Taipei (TW); Cheng-Hung Huang, Miaoli Hsien (TW)

Correspondence Address: BACON & THOMAS, PLLC, 625 SLATERS LANE, FOURTH FLOOR, ALEXANDRIA, VA, 22314

(73) Assignee: Sin Etke Technology Co., Ltd., Taipei City (TW)

(21) Appl. No.: 10/157,919

(22) Filed: May 31, 2002

(30) Foreign Application Priority Data
Mar. 27, 2002 (TW) 91106079

(51) Int. Cl. B60R 25/10

(52) U.S. Cl. 701/36; 340/426.2

(57) ABSTRACT

An active rescue-asking alarm system used in a motor vehicle is constructed to include an alarm, a plurality of sensors, and a wireless communication apparatus, and adapted to send an abnormal signal to the alarm when the sensors detect an abnormal motor vehicle condition while the motor vehicle is turned off. The alarm has an electric connection line connected to the wireless communication apparatus and is adapted for providing a control signal to initiate the wireless communication apparatus when the alarm receives an abnormal signal from the sensors, allowing the wireless communication apparatus to dial up the motor vehicle owner or a call-center, informing the owner of the occurrence of an abnormal motor vehicle condition.

### BACKGROUND OF THE INVENTION

1. Field of the Invention

The present invention relates to a burglar alarm system and its method and, more particularly, to an active rescue-asking alarm system used in motor vehicles that actively sends a rescue-asking message when an abnormal condition occurs to the motor vehicle.

2. Description of Related Art

A burglar alarm system is usually installed in cars to protect against burglars. The car owner activates the burglar alarm system when leaving the car to detect abnormal conditions. When an abnormal condition occurs, for example, the attempted theft of the car, the burglar alarm system sensor is triggered, activating the audio alarm of the burglar alarm system. The sharp warning sounds may dissuade the burglar and call the attention of people passing by and/or the car owner may become aware of the burglar. However, because the audio alarms sharp warning sound has a limited radius, the car owner may not hear the sharp warning sounds and take the necessary steps in time if the car owner is outside the limited radius. The car owner knows that someone has stolen his (her) car only after returning to the parking place. Further, the audio alarm's sharp warning sound disrupts the surroundings if the audio alarm is not turned off. These problems occur because the alarm system cannot actively inform the car owner of the abnormal car condition occurrence.

Therefore, it is desirable to provide an active rescue-asking alarm system and a method that eliminates the aforesaid drawbacks.

### SUMMARY OF THE INVENTION

The main object of the present invention is to provide an active rescue-asking alarm system and a method that actively informs the owner of the motor vehicle upon the happening of an abnormal condition to the motor vehicle, enabling the owner to know the status of the motor vehicle in time.

To achieve this and other objects of the present invention, the active rescue-asking alarm system comprises a wireless communication apparatus, at least one sensor, and an alarm. The sensor is installed to detect the condition of the motor vehicle and to provide a corresponding signal when an abnormal condition occurs while the car is off The alarm is electrically connected to the sensor and adapted to receive signals from the sensor. The alarm has a connection line electrically connected to the wireless communication apparatus and signals the wireless communication apparatus when the alarm receives a signal from the sensor. The wireless communication apparatus informs the motor vehicle owner of the occurrence of the motor vehicle's abnormal condition.

The active rescue-asking alarm system further comprises a GPS (Global Positioning System) unit adapted to provide the motor vehicle's current location information, enabling the transfer of the motor vehicle's current location information to the motor vehicle owner via the wireless communication apparatus. The wireless communication apparatus actively dials up the mobile telephone of the owner of the motor vehicle, or dials up a call-center, requesting the call-center to inform the owner of the motor vehicle of the occurrence of an abnormal motor vehicle condition, when a signal is received from the alarm.

The invention's active rescue-asking alarm method is to be used in the aforesaid active rescue-asking alarm system, comprising the steps of: (a) the sensor(s) provides a signal when the sensor(s) detects the occurrence of an abnormal motor vehicle condition; (b) the alarm sends a control signal to the wireless communication apparatus through the connection line when the alarm receives a signal from the sensor(s); (c) signalling the wireless communication apparatus when the wireless communication apparatus receives a control signal from the alarm; and (d) allowing the wireless communication apparatus to inform the motor vehicle owner of the occurrence of an abnormal motor vehicle condition

Other objects, advantages, and novel features of the invention will become more apparent from the following detailed description when taken in conjunction with the accompanying drawings.

### BRIEF DESCRIPTION OF THE DRAWINGS

FIG. 1 is a system block diagram of the preferred embodiment of the present invention.

FIG. 2 is a flow chart showing the operation of the present invention.

FIG. 3 is a system block diagram of the call-center according to the present invention.

FIG. 4 is a block diagram of the alarm main program according to the present invention.

### DETAILED DESCRIPTION OF THE PREFERRED EMBODIMENT

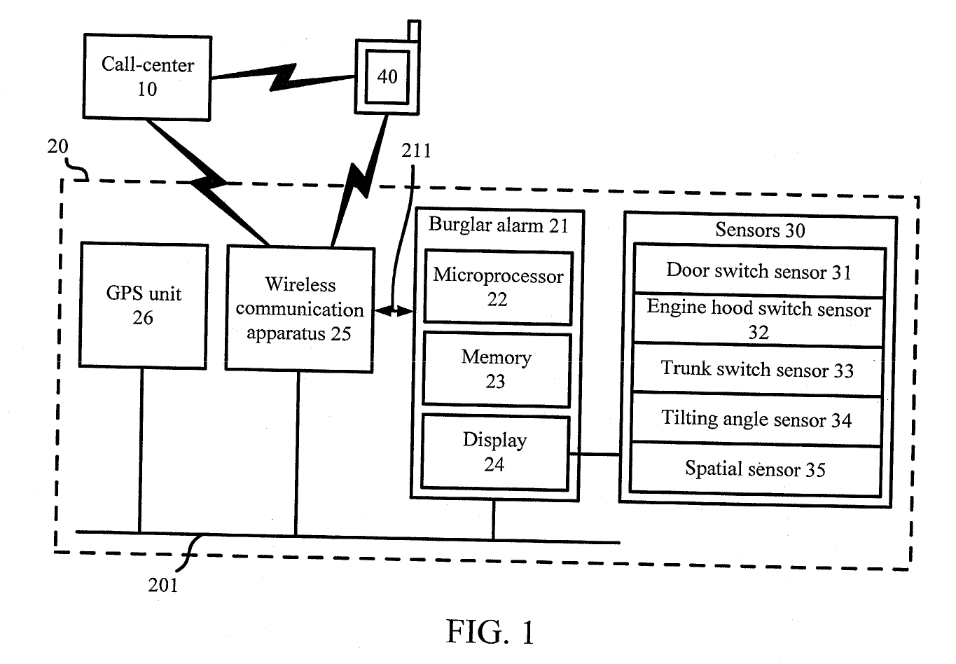

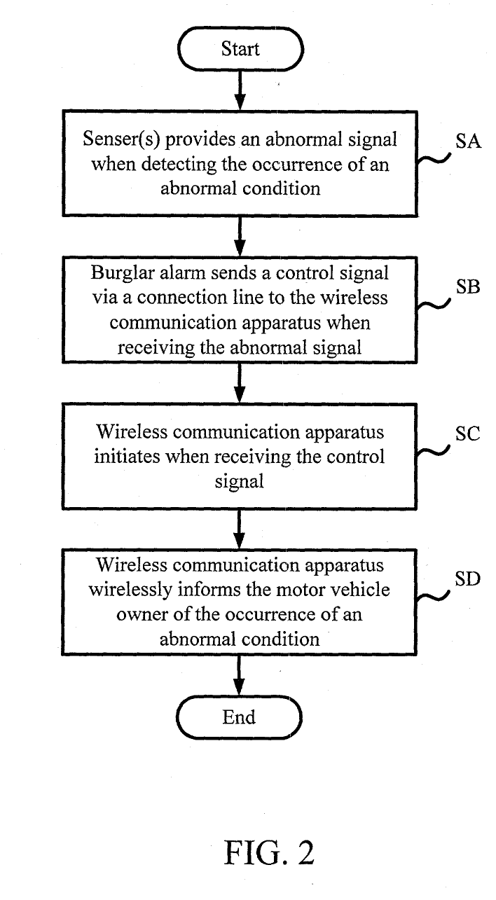

FIG. 1 is a system block diagram of the preferred embodiment of the present invention. FIG. 2 is a flow chart showing the operation of the present invention. The active rescue-asking alarm system 20 is used in a motor vehicle, comprised of a plurality of sensors 30, a burglar alarm 21, a wireless communication apparatus 25, and a GPS unit 26. A bus line 201 is used to connect the parts of the active rescue-asking alarm system 20.

It is to be emphasized that the burglar alarm 21 has an electric connection line 211 with the wireless communication apparatus 25. When one of the sensors 30 detects an abnormal condition and outputs a abnormal signal after the motor vehicle had been set under alarm mode (step SA), the burglar alarm 21 receives the abnormal signal and then sends a control signal to the wireless communication apparatus 25 via the electric connection line 211 (step SB), thereby initiating communication with the wireless communication apparatus 25 (step SC) registering at the base station and dialing up a call-center 10 or the motor vehicle owner's mobile telephone 40 (step SD), informing the motor vehicle owner of the occurrence of an abnormal condition.

The aforesaid wireless communication apparatus 25 can be a GSM (Global System for Mobile Communications), or a GPRS (General Packet Radio Service), or any of a variety of equivalent communication devices. The GPS unit 26 provides the motor vehicle's current position information, for example, longitude and latitude coordinates, and sends the information to the motor vehicle owner through the wireless communication apparatus 25, enabling the motor vehicle owner to trace the motor vehicle. Any equivalent apparatus capable of providing the motor vehicle's current position can be used as the GPS unit 26.

Each sensor 30 provides a particular function, and is installed in a particular location in the motor vehicle. When the engine is turned off and the owner has left the motor vehicle, the sensors 30 scan the respective areas to detect the occurrence of any abnormalities. For example, the door switch sensors 31 are installed in the motor vehicle's door borders to detect the motor vehicle's door closing/opening status. When the motor vehicle's door is opened, an abnormality is occurring. The engine hood switch sensor 32 is installed in the engine hood border area to detect the motor vehicles engine hood closing/opening status. When the motor vehicle's engine hood is opened, an abnormality is occurring. The trunk switch sensor 33 is installed in the motor vehicle's trunk border area to detect the motor vehicle's trunk closing/opening status. When the trunk of the motor vehicle is opened, an abnormality is occurring. The tilting angle sensor 34 is installed in the motor vehicle at a suitable location to detect the motor vehicle's tilting angle. When the motor vehicles tilting angle has surpassed a predetermined value, an abnormality is occurring. For example, when the motor vehicle has tilted over 15° or 20°, the motor vehicle has been damaged. The spatial sensor 35 is installed in the motor vehicles passenger side to detect object movement in the passenger side. If there is detection of moving objects on the passengers side then an abnormality is occurring. The spatial sensor 35 can be an infrared sensor or thermal sensor.

The sensors 30 detection results are analyzed by means of Boolean expression so as to accurately judge different abnormalities and to eliminate a misjudgment. According to the present preferred embodiment, there are five types of sensors 30 installed in the motor vehicle. The number and types of the sensors 30 may be increased or reduced subject to actual requirement. For example, smoke sensor means, flood sensor means, temperature sensor means, etc., may be added to enhance the function of the burglar alarm system.

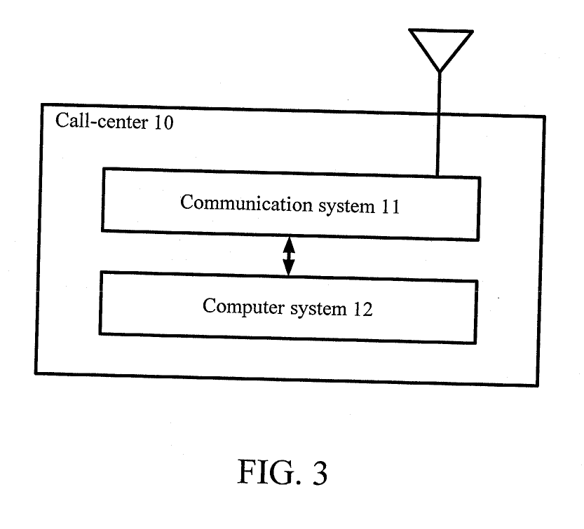

When an abnormality occurs, the wireless communication apparatus 25 (GSM wireless telephone) actively dials up one call-center 10, directing the call-center 10 to dial-up the motor vehicle owner's mobile telephone 40. The system block diagram of the call-center 10, as shown in FIG. 3, comprises a communication system 11 that connects to the wireless communication apparatus 25, and a computer system 12. The call-center 10 monitors the motor vehicle's internal conditions through the wireless communication apparatus 25 when connected, or communicates with the wireless communication apparatus 25 to trace the motor vehicle's status. Therefore, if the motor vehicle owner touches one sensor 30 accidentally, the call-center 10 disarms the alarm after identifying the motor vehicle owner (for example, by asking the motor vehicle owner to input the password). If an abnormal condition actually occurs, for example, the motor vehicle was taken away unlawfully, the call-center 10 immediately dials up the motor vehicle owner's mobile telephone 40, sends a short message to the motor vehicle owner's mobile telephone 40 or a message to the fax machine in the motor vehicle owner's home or office or an e-mail to the motor vehicle owner's e-mail address, or sends a serviceman to contact the motor vehicle owner personally.

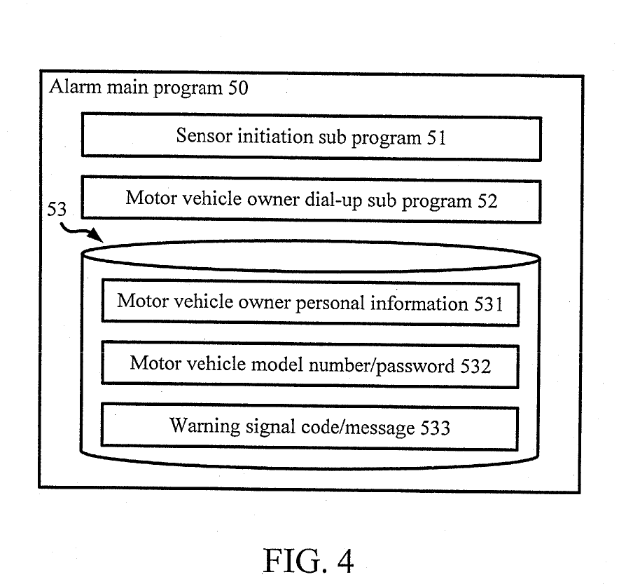

The burglar alarm 21 microprocessor 22 (see FIG. 1) runs the alarm main program 50 (see FIG. 4) from the memory 23 (see FIG. 1) to achieve the afore said task. The alarm main program 50 comprises a sensor initiation sub program 51 that scans the sensors 30 and sends a corresponding control signal to initiate (wake up) the wireless communication apparatus 25 (GSM wireless telephone) through the electric connection line 211 when an abnormal signal is recognized by a sensor 30. The alarm main program 50 further comprises a motor vehicle owner dial-up sub program 52 that allows the wireless communication apparatus 25 to dial up the call-center 10 when the wireless communication apparatus 25 is initiated.

The alarm main program 50 has a database 53 built therein (see FIG. 4) for storing the motor vehicle owner personal information 531, motor vehicle model number/password 532, and warning signal code/message 533. When the wireless communication apparatus 25 has dialed up the call-center 10, it simultaneously transmits the motor vehicle owner personal information 531, motor vehicle model number/password 532, and warning signal code/message 533 from the database 53 to the call-center 10, enabling the call-center 10 to identify the motor vehicle's owner and the motor vehicle's status. For simplification's sake, the telephone number of the wireless communication apparatus 25 is set as the model number of the motor vehicle. When the wireless communication apparatus 25 connects to the call-center 10, the call-center 10 immediately knows the identity of the motor vehicle and its owner through the Caller ID number (calling line identification). The motor vehicles engine number can be used as the motor vehicle's model number. Of course, the motor vehicle distributor can identify the motor vehicle model.

Since multiple sensors 30 are installed in the motor vehicle, different warning signal codes are used to distinguish detection conditions. For example, the warning signal code “1” indicates the occurrence of an abnormality detected by the door switch sensors 31; the warning signal code “2” indicates the occurrence of an abnormality detected by the engine hood switch sensor 32; the warning signal code “3” indicates the occurrence of an abnormality detected by the trunk switch sensor 33; and so on. Thus, the call-center 10 immediately knows the occurring abnormality type and takes the necessary steps when received a signal.

Because the alarm main program 50 database 53 has warning messages installed therein, the warning signal code is displayed on the burglar alarm 21 display 24 (see FIG. 1) and converted into a corresponding short message to inform the motor vehicle owner when a message is received by the call-center 10. For example, when the spatial sensor 35 detects the occurrence of an abnormality, the call-center 10 transmits the short message to the motor vehicle owner: “This is the call-center. Someone has intruded into your motor vehicle. Please take a look!” The short message can be delivered through text or voice. According to the present preferred embodiment, the call-center 10 directly dials up the motor vehicle owner's mobile telephone 40. Alternatively, the wireless communication apparatus 25 can directly dial up the motor vehicle home telephone, office telephone, pager number, or the telephone connectable to the motor vehicle owner, or send a warning message to the motor vehicle owner's fax machine or e-mail address without using the call-center 10.

Finally, the motor vehicle owner or the call-center 10 can actively respond to attempted thefts requesting the active rescue-asking alarm system 20 to accept and execute an instruction. For example, the call-center 10 sends an instruction to the wireless communication apparatus 25, allowing the active rescue-asking alarm system 20 to lock the doors of the motor vehicle, to produce an audio alarm signal to dissuade the burglars, or to provide the motor vehicle's location information through the GPS unit 26 enabling the motor vehicle owner to trace motor vehicle status.

As indicated above, when an abnormal condition occurs, the wireless communication apparatus 25 dials up the call-center 10 or the motor vehicle owner's mobile telephone 40 to ask for assistance. Therefore, the motor vehicle owner knows the motor vehicle situation and can take the necessary protective measures.

Although the present invention has been explained in relation to its preferred embodiments, it is to be understood that many other possible modifications and variations can be made without departing from the spirit and scope of the invention as hereinafter claimed.

What is claimed is:

1. An active rescue-asking alarm system used in a motor vehicle, comprising:
a wireless communication apparatus;
at least one sensor respectively installed in a respective location in the motor vehicle to detect the condition of the motor vehicle and to provide a corresponding abnormal signal when an abnormal motor vehicle condition occurs while the motor vehicle is turned off; and
an alarm electrically connected to said sensor(s) and adapted to receive the abnormal signal from said sensor(s) while the motor vehicle is turned off, said alarm having a connection line electrically connected to said wireless communication apparatus and adapted for providing a control signal to initiate said wireless communication apparatus when said alarm receives the abnormal signal from said sensor(s), and allowing said wireless communication apparatus to inform the motor vehicle owner of the occurrence of the abnormal motor vehicle condition of the motor vehicle.

2. The active rescue-asking alarm system as claimed in claim 1, wherein said wireless communication apparatus is a GSM wireless telephone.

3. The active rescue-asking alarm system as claimed in claim 1 further comprising a GPS unit adapted to provide the current location information of the motor vehicle, enabling the current location information of the motor vehicle to be transferred to the motor vehicle owner wirelessly by said wireless communication apparatus.

4. The active rescue-asking alarm system as claimed in claim 1, wherein said sensor(s) includes a plurality of door switch sensors respectively installed in the borders of the doors of the motor vehicle and each adapted to provide an abnormal signal when a motor vehicle's door is opened while the motor vehicle is turned off.

5. The active rescue-asking alarm system as claimed in claim 1, wherein said sensor(s) includes one engine hood switch sensor installed in the engine hood border of the motor vehicle and adapted to provide an abnormal signal when the motor vehicle's engine hood is opened while the motor vehicle is turned off.

6. The active rescue-asking alarm system as claimed in claim 1, wherein said sensor(s) includes one trunk switch sensor installed in the trunk border of the motor vehicle and adapted to provide an abnormal signal when the motor vehicle's trunk is opened while the motor vehicle is turned off.

7. The active rescue-asking alarm system as claimed in claim 1, wherein said sensor(s) includes a tilting angle sensor adapted to provide an abnormal signal when the motor vehicle is tilted over a predetermined tilting angle while the motor vehicle is turned off.

8. The active rescue-asking alarm system as claimed in claim 1, wherein said sensor(s) includes a spatial sensor installed in the passenger room of the motor vehicle and adapted to provide an abnormal signal when an object moves in the passenger room of the motor vehicle while the motor vehicle is turned off.

9. The active rescue-asking alarm system as claimed in claim 1, wherein said wireless communication apparatus is adapted to dial up the motor vehicle owner's mobile telephone when the control signal is received from said alarm.

10. The active rescue-asking alarm system as claimed in claim 1, wherein said wireless communication apparatus is adapted to dial up a call-center, requesting said call-center to inform the motor vehicle owner of the occurrence of an abnormal motor vehicle condition when the control signal is received from said alarm.

11. The active rescue-asking alarm system as claimed in claim 10, wherein said call-center dials up the mobile telephone of the motor vehicle owner when called by said wireless communication apparatus, informing the motor vehicle owner of the occurrence of an abnormal motor vehicle condition.

12. An active rescue-asking alarm method used in an active rescue-asking alarm system, said active rescue-asking alarm system comprising a wireless communication apparatus, at least one sensor, and an alarm, said sensor(s) respectively installed in a respective location in the motor vehicle, said alarm electrically connected to said sensor(s), and said alarm having a connection line electrically connected to said wireless communication apparatus, the active rescue-asking alarm method comprising the steps of:
(A) allowing said sensor(s) to provide an abnormal signal when said sensor(s) detects the occurrence of an abnormal motor vehicle condition;
(B) allowing said alarm to send a control signal to said wireless communication apparatus through said connection line when said alarm receives the abnormal signal from said sensor(s);
(C) initiating said wireless communication apparatus when said wireless communication apparatus received the control signal from said alarm; and
(D) allowing said wireless communication apparatus to inform the motor vehicle owner of the occurrence of an abnormal motor vehicle condition when initiated said wireless communication apparatus.

13. The active rescue-asking alarm method as claimed in claim 12, wherein said active rescue-asking alarm system further comprises a GPS unit adapted to provide the current location information of the motor vehicle, wherein the step (D) further includes the sub-step of allowing said wireless communication apparatus to inform the motor vehicle owner with the current motor vehicle location.

14. The active rescue-asking alarm method as claimed in claim 12, wherein the step (D), said wireless communication apparatus is allowed to dial up the motor vehicle owner's mobile telephone to inform the motor vehicle owner of the occurrence of an abnormal motor vehicle condition when initiated said wireless communication apparatus.

15. The active rescue-asking alarm method as claimed in claim 12, wherein the step (D), said wireless communication apparatus is allowed to dial up a call-center, requesting said call-center to inform the motor vehicle owner of the occurrence of an abnormal motor vehicle condition when initiating said wireless communication apparatus.

16. The active rescue-asking alarm method as claimed in claim 15, wherein said call-center informs the motor vehicle owner of the occurrence of an abnormal motor vehicle condition by dialing up the mobile telephone of the motor vehicle owner.
